(19) United States
(12) Patent Application Publication
(10) Pub. No.: US 2014/0276296 A1
(43) Pub. Date: Sep. 18, 2014

(54) Deep Vein Thrombosis Prevention Garment Having Integrated Fill Tube

(71) Applicant: Compression Therapy Concepts, Inc., Eatontown, NJ (US)

(72) Inventors: Orlando Mansur, JR., Eatontown, NJ (US); Leonard Nass, Eatontown, NJ (US)

(21) Appl. No.: 14/217,178

(22) Filed: Mar. 17, 2014

Related U.S. Application Data
(60) Provisional application No. 61/786,360, filed on Mar. 15, 2013.

(51) Int. Cl. A61H 9/00; A61H 1/00

(52) U.S. Cl. CPC A61H 9/0078; A61H 1/008
USPC 601/152; 601/151

(57) ABSTRACT

A deep vein thrombosis prevention garment includes three (3) chambered polymer having an integral welded filling tube forming three (3) sequentially filled air chambers. The aft chambers receive air from an integrated fill tube attached to pump. When the air within the first air chamber reaches a predetermined air pressure, air begins to pass into a second air chamber at a higher rate, and similarly, when the air within the second air chamber reaches a predetermined air pressure, air passes into the third air chamber at another higher rate to reach the predetermined air pressure. The different internal diameters of the integrated fill tube outlets for each air chamber provide different air flow rates, resulting in staged inflation of air chambers. A membrane panel allows air to escape the sequentially filled air chambers.

### RELATED APPLICATION

This application claims the benefit of priority to U.S. Provisional Application No. 61/786,360, filed on Mar. 15, 2013, entitled “Deep Vein Thrombosis Prevention Garment Having Integrated Fill Tube”, and currently co-pending.

### FIELD OF THE INVENTION

The present invention relates generally to medical and therapy devices. The present invention is more particularly useful as a compression garment for use in the prevention of deep vein thrombosis. The present invention is particularly useful to prevent deep vein thrombosis during periods of low or no activity by continually circulating blood through a patient's extremities,

### BACKGROUND OF THE INVENTION

Deep Vein Thrombosis, or “DVT,” is a blood clot (“thrombus”) that forms in a vein deep in the body. A thrombus occurs when blood thickens and clumps together. Most of these thrombi occur in the lower leg or thigh; however, they can also occur in other parts of the body. Thrombi located in the thigh are more likely to break off and cause a pulmonary embolism (“PE”) that dots in the lower leg or other parts of the body. The dots that form dose to the skin usually cannot break off and cause a PE due to their reduced size and the reduced pressures exerted on them.

A DVT, or a portion of it, can break off and travel through the bloodstream where it can enter the lung and block blood flow. This condition is called a pulmonary embolism, which is considered to be very serious due to its likelihood of causing damage to the lungs and other organs and quite possibly leading to death. This condition affects more than 2.5 million Americans each year and is associated with an estimated 50,000 to 200,000 deaths annually.

The venous system is designed to allow for the return of blood to the right side of the heart. Veins are not passive tubes through which blood passes, but are a system that uses muscular compressions, gravity, and inter-venous valves to promote and control the flow of blood through them. The valves are located along the entire length of the vein and ensure that blood only flows in one (1) direction, toward the heart. Blood flow may easily pass through the valve in the direction toward the heart, but when pressure is greater above the valve than below, the cusps will come together, thereby closing the valve and preventing the further flow of blood to the heart.

The valves consist of two (2) very thin-walled cusps that originate at opposite sides of the vein wall and come together to meet at the midline of the vein. The diameter of the vein is slightly larger just behind the valve where the cusps attach to the vein wall. Due to the larger diameter of the vein and the propensity for blood to collect and stagnate between the valve cusps and the vein wall, thrombi formation in this area is more likely.

The most common causes of DVT are venous stasis, blood vessel wall injury, and hypercoagulability. Venous stasis is the reduction of blood flow, most notably in the areas of venous valves, usually caused by extended periods of inactivity. These periods of inactivity minimize the muscular compressions applied to the veins, and remove the forces used to propel the blood through the veins, accordingly. This reduction in flow allows the blood to collect and congeal, thereby forming a dot. The conditions that contribute to venous stasis include heart disease, obesity, dehydration, pregnancy, a debilitated or bed-ridden state, stroke, and surgery. Stasis has been known to develop with surgical procedures lasting as little as thirty (30) minutes.

Vessel wall injury can disrupt the lining of the vein, thereby removing the natural protections against dotting. The loss of natural protection will increase the chances of dot formation and the subsequent mobilization of the dot that can lead to a PE. Some of the major causes of vessel wall injury are trauma from fractures and burns, infection, punctures of the vein, injection of irritant solutions, susceptibility to DVT, and major surgeries.

Hypercoagulability exists when coagulation outpaces fibrinolysis, which is the body's natural mechanism to inhibit dot formation. When this condition exists, the chances of dot formation, especially in areas of low blood flow, are greatly increased. Some causes of hypercoagulability are trauma, surgery, malignancy, and systemic infection, A typical treatment is the administration of an anti-coagulant such as low-molecular-weight heparin.

It is recognized that clots usually develop first in the calf veins and “grow” in the direction of flow in the vein. The clots usually form where blood flow is lowest. Once a clot forms, it either enlarges until it is enveloped, which causes the coagulation process to stop, or the clot may develop a “tail” which has a high chance of breaking off and becoming mobile where it can enter the pulmonary system and become lodged in the lungs.

In a patient with DVT, the goals are to minimize the risk of a PE, limit further clots, and facilitate the resolution of existing dots. If a potential dot is suspected or detected, bed rest is usually recommended to allow for the dot to stabilize and adhere to the vein wall, thereby minimizing the chance of the dot becoming mobile such that it can travel to the lungs. A more effective preventative measure is ambulation, which is to walk about or move from place to place. Ambulation requires muscle movement. The muscle movement will provide a continuous series of compressions to the veins, thereby facilitating the flow of blood. The continuous flow of blood will reduce or eliminate any areas of stasis so dots do not have a chance to form. For people who are confined to a bed or will be immobile for an extended period of time, leg elevation is recommended. This will promote blood return to the heart and will decrease any existing venous congestion.

Graduated compression stockings have also been used to apply pressure to the veins so as to reduce or minimize any areas of low flow in the vein, while not allowing the collection and coagulation of blood in these low flow areas. The stockings are designed to provide the highest level of compression to the ankle and calf area, with gradually decreasing pressure continuing up the leg. The stockings prevent DVT by augmenting the velocity of venous return from the legs, thereby reducing venous stasis. Typically, stockings are applied before surgery and are worn until the patient is fully able to move on their own. The stockings need to fit properly and be applied correctly. If too tight, they may exert a tourniquet effect, thereby promoting venous stasis, the very problem trying to be prevented. If too loose, the stockings will not provide adequate compression.

Another treatment of DVT involves the use of intermittent pneumatic compression (IPC). IPC can be of benefit to patients deemed to be at risk of deep vein thrombosis during extended periods of inactivity and is an accepted treatment method for preventing blood clots or complications of venous stasis in persons after physical trauma, orthopedic surgery, neurosurgery, or in disabled persons who are unable to walk or mobilize effectively.

An IPC uses an air pump to inflate and deflate airtight sleeves wrapped around the leg. The successive inflation and deflations simulate the series of compressions applied to the veins from muscle contractions, thereby limiting any stasis that can lead to thrombi formation. This technique is also used to stop blood clots from developing during surgeries that will last for an extended period of time. Another version of IPC is the Venous Foot Pump which provides an alternative to the traditional thigh or calf compression device. The foot pump mimics the natural effects of walking and weight-bearing on the circulation in the feet and legs through compressions applied to the foot. PE remains the most common preventable cause of death in hospitalized patient. The deaths are most often a complication resulting from the formation of a DVT and the subsequent PE that may result from it.

In light of the above, it would be advantageous to provide a deep vein thrombosis prevention garment that minimizes the occurrence of deep vein thrombosis formation. It would be further advantageous to provide a deep vein thrombosis prevention garment that allows medical personnel to customize the compression of limbs being treated to optimize treatments for particular patients. It is a further advantage to provide a deep vein thrombosis prevention garment that provides a sequential inflation of pressure-producing chambers with a single air input. It would also be advantageous to provide a deep vein thrombosis prevention garment that is easy to use, relatively easy to manufacture, and comparatively cost efficient.

### SUMMARY OF THE INVENTION

The deep vein thrombosis prevention garment having integrated fill tube of the present invention (hereafter referred to as the “deep vein thrombosis prevention garment”) includes a central panel, a left side panel, and a right side panel formed with a number of attachment straps having an integral fastener, such as Velcro brand hook and bop fasteners. The central panel is formed to have three (3) sequentially filled air chambers separated from each other. The first air filled chamber receives air from a pump through a flexible air supply tube and an integrated fill tube.

The integrated fill tube includes three (3) air outlets having different diameters to provide staged inflation to each air chamber. When the air within the first air filled chamber reaches a predetermined air pressure, the air introduced into the integrated fill tube begins to pass at a higher rate into the second air filled chamber. Likewise, when the air within the second air filled chamber reaches a predetermined air pressure, the air begins to pass at another higher rate into the third air filled chamber.

In the event that the air pressures within the first, second or third air filled chamber exceeds a predetermined maximum, a membrane panel formed in the third air filled chamber allows air to escape the sequentially filled air chambers. The membrane can have a threshold pressure which prevents air from passing through the membrane until that threshold is exceeded.

The deep vein thrombosis prevention garment of the present invention is worn by a patient on an extremity that is subject to development of thrombosis, particularly deep vein thrombosis, and particularly during surgery or extended periods of inactivity. In use, the deep vein thrombosis prevention garment may be wrapped snugly around a patient's leg. Once activated, the pump provides a periodic air supply to the garment through the flexible air supply tube leading to the first air filled chamber.

As the first air filled chamber becomes partially inflated, the first air filled chamber fills with air to provide pressure on the leg of the patient to urge blood flow upward through the leg. As this air pressure is maintained through the flexible air supply tube, the first air filled chamber becomes pressurized to a predetermined pressure, such as 35 mmHg, and air begins to pass to the second air filled chamber. As the second air filled chamber inflates, it provides additional pressure on the leg of the patient to urge blood flow further upward through the leg.

As the air pressure is continued through the flexible air supply tube, the first air filled chamber and second air filled chamber become inflated to a predetermined pressure, and air begins to pass through the third air filled chamber. As the third air filled chamber inflates, it provides additional pressure on the leg of the patient to urge blood flow even further upward through the leg.

The sequential inflation of the first air filled chamber, second air filled chamber and third air filled chamber creates a peristaltic force on the veins within the limb being treated. Once all three (3) air filled chambers are pressurized to a predetermined pressure, the pressurized air supplied to the flexible air supply tube is discontinued, and all three (3) air filled chambers deflate, returning the deep vein thrombosis prevention garment of the present invention to its fully un-inflated configuration. In this fully un-inflated configuration, blood flows freely through the limb being treated.

The inflation and deflation timing cycle of the deep vein thrombosis prevention garment of the present invention is determined by the pressures being utilized, and the speed by which the air filled chambers deflate. In order to effectively urge blood flow through deep veins, the timing for the peristaltic effect of the deep vein thrombosis prevention garment of the present invention is approximately twenty (20) seconds per cycle.

### BRIEF DESCRIPTION OF TIDE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a top plan view of the deep vein thrombosis prevention garment of the present invention showing a central panel, a left side panel, and a right side panel formed with a number of attachment straps having an integral fastener, and with the central panel having three (3) sequentially filled air chambers (shown in dashed lines) receiving air from a pump through a flexible air supply tube;

FIG. 2 is a view of the deep vein thrombosis prevention garment of the present invention being used by a patient for the prevention of deep vein thrombosis, showing a pump supplying pressurized air through a flexible air supply tube;

FIGS. 3-6 depict the deep vein thrombosis prevention garment of the present invention as used on the leg of a patient starting with an un-inflated configuration, and advancing through the inflation of each sequential air filled chamber; FIG. 3 is an exemplary partial cross-sectional view of the deep vein thrombosis prevention garment of the present invention as used on the leg of the patient, showing the deep vein thrombosis prevention garment in a deflated configuration in which little or no pressure is exerted on the leg of the patient and blood flows unrestrictedly through the leg;

FIG. 4 is an exemplary partial cross-sectional view of the deep vein thrombosis, prevention garment of the present invention as used on the leg of the patient, showing the deep vein thrombosis prevention garment in a partially inflated configuration with the first air filled chamber filled with air to provide pressure on the leg of the patient to urge blood flow upward through the leg;

FIG. 5 is an exemplary partial cross-sectional view of the deep vein thrombosis prevention garment of the present invention as used on the leg of the patient, showing the deep vein thrombosis prevention garment in a partially inflated configuration with the first air filled chamber filled with air to provide pressure on the leg and fill the second air filled chamber to provide additional pressure on the leg of the patient to urge blood flow further upward through the leg;

FIG. 6 is an exemplary partial cross-sectional view of the deep vein thrombosis prevention garment of the present invention as used on the leg of the patient, showing the deep vein thrombosis prevention garment in a fully inflated configuration with the first air filled chamber filled with air to provide pressure on the leg and fill the second aft filled chamber, and the second air filled chamber filled with air to provide additional pressure on the leg and fill the third air filled chamber to provide yet additional pressure on the leg of the patient to urge blood flow further upward through the leg;

FIG. 7 is a graphical representation of the air pressure supplied from the pump to the deep vein thrombosis prevention garment of the present invention, showing a maximum air pressure to be delivered, and the sequential pressure within each of the air filled chambers during a sequential Inflation cycle before pressure supplied from the pump is released and all air filled chambers deflate;

FIG. 8 is a diagrammatic view of a preferred embodiment of the deep vein thrombosis prevention garment of the present invention, equipped within a central panel, showing a three-chamber polymer air bladder, each connected via an integrated fill tube that provides for the passage of air to the first chamber, the second chamber, and the third chamber;

FIG. 9 is a cross-sectional view of the preferred embodiment of the deep vein thrombosis prevention garment of the present invention taken along line 9-9 of FIG. 8, depicting that air outlet channels on the integrated fill tube and the air bladder are made of the same materials, when the air chambers are deflated; and

FIG. 10 is a cross-sectional view of the preferred embodiment of the deep vein thrombosis prevention garment of the present invention taken along line 10-10 of FIG. 8, showing the integrated fill tube that facilitates the flow of air to the first, second and third chambers, when the first air chamber is partially inflated.

### DETAILED DESCRIPTION OF A PREFERRED EMBODIMENT

Referring initially to FIG. 1, FIG. 1 is a top plan view of the deep vein thrombosis prevention garment of the present invention generally designated 100. Garment 100 includes a central panel 102, a left side panel 104, and a right side panel 106. Garment panels 102, 104, and 106 are flexible and formed with an inside layer 105, an outside layer 103, and a perimeter binding 107 stitching the inside layer 105 and the outside layer 103 together. In a preferred embodiment, the inside layer 105 and the outside layer 103 of the deep vein thrombosis prevention garment 100 are made from durable cloth or other non-woven material that can comfortably contact a patient's skin.

A flexible air supply tube 108 enters central panel 102 and is connected to the integrated fill tube 158 that leads to a series of sequentially filled air chambers 110, 112, and 114 (shown in dashed lines), through the air outlets 156, 154, and 152, respectively. This flexible air supply tube 108 is shown having a non-descript length. It is to be appreciated that the length of the tube 108 may vary depending on the particular field of use and the setting. For instance, in a hospital surgery setting, it may be difficult to position an air source immediately adjacent to the patient, and an extended air supply tube 108 is required.

Air is supplied to the flexible air supply tube 108 from a pump 140. In a preferred embodiment, pump 140 includes a compressor capable of providing a predetermined maximum air pressure to fill the sequentially filled air chambers 110, 112, and 114. As will be described in greater detail below, pump 140 can provide air at a predetermined pressure for a predetermined period of time, providing for an inflation and deflation cycle according to the desired therapy parameters.

As shown in FIG. 1, right side panel 106 is formed with a number of attachment straps 124, 126, and 128, with each strap having an integral fastener 130, 132, and 134, respectively. In a preferred embodiment, straps 124, 126, and 128 are provided with a hook-and-loop style fastener 130, 132, and 134. These hook-and-loop fasteners cooperate with the outside layer 103 of panels 102 and 104 to allow the deep vein thrombosis prevention garment 100 of the present invention to be positioned about a patient's limb and secured in place by wrapping the panels 102, 104 and 106 around the limb and firmly pressing the fasteners 130, 132, and 134 on straps 124, 128, and 128 against the outside layer 103. The hook-and-loop fasteners are attached to the outside layer 103 to hold the straps 124, 126, and 128 in place. This type of fastener and method of attachment of the deep vein thrombosis prevention garment 100 provide a deep vein thrombosis prevention garment 100 for patients having limbs of different sizes and can accommodate large or small diameter limbs simply by wrapping the panels 102, 104 and 106 around the limb and securing straps 124, 126, and 128 in place.

While the deep vein thrombosis prevention garment 100 of the present invention in a preferred embodiment is manufactured having a hook-and-loop type fastener 130, 132, and 134, it is to be appreciated that any other types of fastener known in the art may be used without departing from the present invention.

Referring now to FIG. 2, the deep vein thrombosis prevention garment 100 of the present invention being used by a patient 50 for the prevention of deep vein thrombosis is shown. Specifically, as shown, the deep vein thrombosis prevention garment 100 is positioned around the lower leg 52 or calf of patient 50, in communication with pump 140 through flexible air supply tube 108. Pump 140 supplies pressurized air through flexible air supply tube 108 and integrated fill tube 158 (shown in FIG. 1) to pressurize the sequentially filled air chambers 110, 112, and 114 (shown in FIG. 1).

FIG. 2 depicts a patient in a sitting position and this shows merely an exemplary use of the deep vein thrombosis prevention garment 100 of the present invention. Indeed, the deep vein thrombosis prevention garment of the present invention may be used with patients virtually in any position. As will be described in greater detail below, the inflation and deflation cycle of the sequentially filled air chambers 110, 112, and 114 may vary depending on the particular patient, and the particular environment. For instance, a patient using the deep vein thrombosis prevention garment of the present invention in a sitting position may opt for a faster inflation and deflation cycle, and may utilize higher air pressures in the sequentially filled air chambers 110, 112, and 114 than a patient using the deep vein thrombosis prevention garment in a supine position on an operating table.

It is also to be appreciated that while FIG. 2 depicts a patient 50 having one (1) deep vein thrombosis prevention garment on a leg, a number of deep vein thrombosis prevention garments may be used simultaneously. For instance, in a surgery setting, it is commonplace to utilize the deep vein thrombosis prevention garment of the present invention on both legs.

As shown in FIG. 2, the deep vein thrombosis prevention garment 100 is positioned around the calf 52 of a patient 50 by positioning panels 102 and 104 (shown in FIG. 1) against the patient's leg, wrapping straps 124, 126, and 128 around the calf 52, and then securing the straps to the outside layer 103 (shown in FIG. 1) of panel 102 and 104 with fasteners 130, 132, and 134 (shown in FIG. 1).

Referring now to FIGS. 3 through 6, exemplary views of the deep vein thrombosis prevention garment 100 of the present invention, as used on the leg 52 of a patient 50 (shown in FIG. 2), starting with an un-inflated configuration in FIG. 3, and advancing through the inflation of each sequentially filled air chamber in FIG. 6, are depicted.

Starting with FIG. 3, an exemplary partial cross-sectional view of the deep vein thrombosis prevention garment 100 of the present invention in a deflated configuration, as used on the leg 52 of the patient, is depicted. In the deflated configuration, little or no pressure is exerted on the leg 52 of the patient and blood flows through the leg without restriction. As depicted in FIG. 4, as air is introduced into the flexible air supply tube 108 (shown in FIGS. 1-2) and integrated fill tube 158 (shown in FIG. 1), and the air begins to fill the first air filled chamber 110 at a higher rate than other air chambers through air outlet 156 (shown in FIG. 1), air pressure is introduced to the leg 52 to urge blood within the leg flow upward in direction 150.

As air is continually introduced into the air chambers 110, 112, and 114, a predetermined minimum pressure is reached first in the first aft filled chamber 110. Then air introduced into the integrated fill tube 158 begins to pass at a higher rate into the second air filled chamber 112, through air outlet 154 (shown in FIG. 1). As the second air filled chamber 112 inflates, it provides additional pressure on the leg 52 of the patient to urge blood flow further upward through the leg in direction 150, as shown in FIG. 5.

As air is continually introduced into the integrated fill tube 158 and when a minimum pressure is reached in the second air filled chamber 112, air begins to pass at another higher rate into the third air filled chamber 114, through aft outlet 152 (shown in FIG. 1). As the third air filled chamber 114 inflates, it also provides additional pressure on the leg 52 of the patient 50 to urge blood flow further upward through the leg in direction 150, as shown in FIG. 6.

When a single inflation cycle is completed, the air pump 140 (shown in FIGS. 1-2) releases the air pressure to the integrated fill tube 158 (shown in FIG. 1) and the flexible air supply tube 108 (shown in FIGS. 1-2), and the air dissipates through the flexible air supply tube 108 and through the pressure membrane (not shown), to return the deep vein thrombosis prevention garment 100 of the present invention to its originally deflated state, as shown in FIG. 3. This cycle is repeated according to a particular patient profile, and may be repeated for extended periods of time, in order to minimize the likelihood that thrombosis will develop in the patient.

Referring now to FIG. 7, a graphical representation of the air pressure supplied from the pump to the deep vein thrombosis prevention garment of the present invention is shown and generally referred to as 200. Graph 200 includes a vertical Air Pressure axis 202 and a horizontal Time axis 204. This graph 200 depicts a typical inflation and deflation cycle that occurs in the deep vein thrombosis prevention garment of the present invention.

Graph 200 includes a primary supply air pressure curve 206 which corresponds to the air provided by pump 140 (shown in FIGS. 1-2) to flexible air supply tube 108 (shown in FIGS. 1-2) and integrated fill tube 158 (shown in FIG. 1). This air supply begins at the start of the inflation cycle and rises to a maximum supplied air pressure 208. This maximum supplied air pressure 208 is approximately equal to an overall maximum pressure 220 (shown by dashed line) that corresponds to the maximum desired pressure within the sequentially filled air chambers 110, 112, and 114 (shown in FIGS. 1, and 3-6), the maximum pressure medically safe, or any other maximum value utilized in the art to ensure safe operation of the deep vein thrombosis prevention garment 100 of the present invention.

As the pressure within the flexible air supply tube 108 and the integrated fill tube 158 (shown in FIG. 1) is supplied to the first air filled chamber 110 through air outlet 156 (shown in FIG. 1), the pressure 210 within the first air filled chamber 110, the pressure 214 within the second air filled 112, and the pressure 217 within the third air filled chamber 114 begin to increase. Different increase rates for the air pressures within the air chambers 110, 112, and 114 are due to the different air flow rates provided by the different internal diameters for air outlets 156, 154, and 152 (shown in FIG. 1).

As the first air filled chamber 110 begins to reach its maximum capacity, the pressure within the chamber passes the minimum pressure (depicted as value 224), and the air begins to pass through the air outlet 154 of the integrated fill tube 158, into the second air filled chamber 112. Therefore, at time 212 when the first air filled chamber 110 reaches its minimum pressure 224, air begins to pass at a higher rate into the second air filled chamber 112, as shown on the pressure 214. Similarly, at time 212, air begins to pass at a higher rate also into the third air filled chamber 114, as shown on the pressure 217.

The maximum air pressure 208 is maintained and as the air continues to pass into first air filled chamber 110, and into the second air filled chamber 112, the air pressure 214 in the second air filled chamber 112 rises. As the second air filled chamber 112 begins to reach its maximum capacity at a higher rate, the pressure within the second air filled chamber 112 passes the minimum pressure (again depicted as value 224), and the air begins to pass at a higher rate through the air outlet 152 into the third air filled chamber 114. Therefore, at time 216 when the second air filled chamber 112 reaches its minimum pressure 224, air begins to pass at another higher rate into the third air filled chamber 114 to reach its maximum capacity, as shown on the pressure 217.

The inflation cycle is completed once the three (3) sequentially filled air chambers 110, 112, and 114 have had sufficient time to inflate. Following the inflation cycle, the deflation cycle begins at time 218 and the pressure 222 in the flexible air supply tube 108 decreases to zero. It is also contemplated that along with the decrease in the pressure 222 of the flexible air supply tube 108, the pressures 210, 214 and 217 likewise return to zero in substantially the same time. Once this inflation and deflation cycle is completed, a delay may be inserted prior to beginning of the next inflation and deflation cycle.

Using the deep vein thrombosis prevention garment 100 of the present invention, the time for a complete inflation cycle, deflation cycle and delay is approximately twenty (20) seconds. As a result, the deep vein thrombosis prevention garment 100 can be cycled three (3) times every minute in order to provide a continuous force to create the desired peristaltic effect. It is to be appreciated that the specific period for a complete cycle may be changed depending on the size of the limb being treated, the pressure desired, and the peristaltic forces necessary to minimize the likelihood of the development of a thrombosis.

Referring now to FIG. 8, a diagrammatic view of a preferred embodiment of the deep vein thrombosis prevention garment of the present invention, equipped within a central panel 102, showing a three-chamber polymer air bladder each connected via an integral welded filling tube 158 that provides for the passage of air to the first air filled chamber 110, the second air filled chamber 112 and the third air filled chamber 114, is depicted.

Specifically, a flexible air supply tube 108 is connected to the integrated fill tube 158 having air outlets 156, 154, and 152, to the sequentially filled air chambers 110, 112, and 114, formed within welds 111, 113, and 180. As shown, air enters the flexible air supply tube 108 which is connected to the integrated fill tube 158, in direction 151. Air enters the first air filled chamber 110 through the air outlet 156 in direction 166 and passes into the integrated fill tube 158 that provides for the passage of air to the first air filled chamber 110, the second air filled chamber 112, and the third air filled chamber 114. As the air flows in direction 166 through outlet 156 into the first air filled chamber 110, air also flows in direction 170 through outlet 154 into the second air filled chamber 112, and similarly, also in direction 176 through outlet 152 into the third air filled chamber 114.

From this view, it can be appreciated that the internal diameters 164, 168, and 169 of the integrated fill tube outlets 156, 154, and 152, respectively, are different. In a preferred embodiment, the largest diameter 164 of the air outlet 156 is adopted such that air passes into and fills the first air filled chamber 110 first. The diameter 168 of the air outlet 154 within the second air filled chamber 112 can be smaller than that of the air outlet 156, but larger than the diameter 169 of the air outlet 152 of the third air filled chamber 114. Therefore, the third air filled chamber 114 includes the air outlet 152 having a smallest diameter. Such different diameters control the flow of air into the first air filled chamber 110 to the second and third aft filled chambers 112 and 114. These different internal diameters depicted in FIG. 8 are intentionally adopted in order to provide a different air flow rate into the first air filled chamber 110 and to the second and third air filled chambers 112 and 114. By providing different internal diameters, the flow rate of air through the integrated fill tube 158 can be adjusted to provide staged inflation of the air chambers.

FIG. 9 is a cross-sectional view of the deep vein thrombosis prevention garment 100 of the present invention taken along lines 9-9 of FIG. 8, when the air chambers are deflated. FIG. 9 shows the air outlets 156, 154, and 152 of integrated fill tube 158 that facilitates the flow of air to the first, second, and third air filled chambers 110, 112 and 114. From this view, it can be appreciated that the front layer 192 of air bladder formed with three (3) air filled chambers having aft outlets 156, 154, and 152 of integrated fill tube 158, is made of the same material as the rear layer of air bladder 192A. The front layer 192 and rear layer 192A of the air bladder are sealed forming the individual sequentially filled air chambers 110, 112, and 114. Such seals between the front layer 192 and rear layer 192A of air bladder are made by sonic welding, heat sealing, or any other methods known in the art. The seals provide for an air-tight seal between the two (2) layers of air bladder and allow for the pressurization of the resulting chambers. FIG. 10 is a cross-sectional view of the preferred embodiment of the deep vein thrombosis prevention garment 100 of the present invention taken along line 10-10 of FIG. 8, when the first air filled chamber 110 is partially inflated. This Figure shows the air cavity 178 created within the first air filled chamber 110 formed with a front layer 192 and a rear layer 192A of air bladder. In FIG. 10, the aft cavity 178 is partially inflated as air enters into the first air filled chamber 110. FIG. 10 further depicts the cross-sectional view of the integrated fill tube 158 which is formed between the sealed edges 172 and 174 and provides for the passage of aft.

While there have been shown what are presently considered to be preferred embodiments of the present invention, it will be apparent to those skilled in the art that various changes and modifications can be made herein without departing from the scope and spirit of the invention.

1. A deep vein thrombosis prevention garment, comprising:
a central panel having a first polymer layer and a second polymer layer, said first polymer layer and said second polymer layer selectively welded to form a plurality of sequentially filled air chambers and a fill said fill tube in communication with one or more air chambers;
a flexible air supply tube in communication with the fill tube;
a left side panel extending from said central panel;
a right side panel extending from said central panel opposite said left side panel; and
a means for fastening said left side panel to said right side panel.

2. The deep vein thrombosis prevention garment of claim 1, wherein said integrated welded fill tube comprises air outlets which have different diameters and provide different air flow rates between the air chambers.

3. The deep vein thrombosis prevention garment of claim 10, further comprising said predetermined minimum pressure being in the range of 2.5 mmHg to 35 mmHg.

4. The deep vein thrombosis prevention garment of claim 1, further comprising said predetermined minimum pressure being 25 mmHg.

5. The deep vein thrombosis prevention garment of claim 1, further comprising a pump in communication with said air supply tube and said welded filling tube to provide air having a predetermined pressure sufficient to inflate one or more sequentially filled air chambers.

6. The deep vein thrombosis prevention garment of claim 5, wherein said predetermined pressure is 35 mmHg.

7. The deep vein thrombosis prevention garment of claim 1, further comprising said pump configured to provide air at the predetermined pressure for a fixed period of time.

8. The deep vein thrombosis prevention garment of claim 1, further comprising a means for releasing air from said sequentially filled air chambers if said air exceeds a pressure of 35 mmHg.

9. The deep vein thrombosis prevention garment of claim 1, further comprising a means for pressurizing said sequentially filled air chamber to 35 mmHg.

10. The deep vein thrombosis prevention garment of claim 1, further comprising:
An aperture formed in one of the sequentially filled air chambers;
a membrane panel covering the aperture and configured to pass air having a predetermined minimum pressure from the air chamber.

11. The deep vein thrombosis prevention garment of claim 2, further comprising a first air filled chamber, a second air filled chamber, and a third air filled chamber, wherein the air flows at a higher rate into the second air filled chamber when the first air filled chamber reaches a predetermined air pressure, and the air flows at a higher rate into the third air filled chamber when the second air filled chamber reaches a predetermined pressure.
